(19) United States
(12) Patent Application Publication
(10) Pub. No.: US 2026/0117087 A1
(43) Pub. Date: Apr. 30, 2026

(54) METHOD AND SYSTEM FOR PRODUCING A HYDROPHILIC SILICONE-BASED INK AND USE OF THE SAME

(71) Applicants: Xiaowu (Shirley) TANG, Waterloo (CA); Li Yan WONG, Waterloo (CA); Sayan GANGULY, Kitchener (CA)

(72) Inventors: Xiaowu (Shirley) TANG, Waterloo (CA); Li Yan WONG, Waterloo (CA); Sayan GANGULY, Kitchener (CA)

(21) Appl. No.: 19/368,022

(22) Filed: Oct. 24, 2025

Related U.S. Application Data
(60) Provisional application No. 63/833,106, filed on Oct. 24, 2024.

(51) Int. Cl. C09D 151/08; C08F 290/06; C09D 4/06; C09D 7/20

(52) U.S. Cl. CPC C09D 151/085; C08F 290/068; C09D 4/06; C09D 7/20

(57) ABSTRACT

The disclosure is directed at an ink for use in three-dimensional printing. The ink includes an amphiphilic siloxane monomer/oligomer combined with a photo initiator. In some embodiments, the ink may include at least one monomer such as acrylamide and/or glycidyl methacrylate.

### CROSS-REFERENCE TO OTHER APPLICATIONS

The disclosure claims priority from U.S. Provisional No. 63/833,106 filed Oct. 24, 2024 which is hereby incorporated by reference.

### FIELD

The disclosure is directed at three-dimensional (3D) printing and, more specifically, at a method and system for producing a hydrophilic silicone-based ink and use of the same.

### BACKGROUND

The capability of fluidic devices in miniaturizing standard laboratory-scale experiments to chip-scale format with fluid manipulation has contributed to the tremendous rise in demand for fluidic devices. In order to cope with the rising demand for fluidic devices, a highly efficient and cost-effective fabrication method is beneficial for the mass production of fluidic devices at low cost. Conventionally, fluidic devices are fabricated via soft-lithography, which is an extremely time-consuming and expensive process, owing to the multiple steps of material deposition and removal involved and the need for cleanroom facilities. Furthermore, it is found to be exceptionally challenging to produce channels and pole structures with curvature using soft-lithography, which subsequently limits the channel geometry that can be generated with soft-lithography. In conjunction with that, the emergence of three-dimensional (3D) printing has successfully revolutionized the field of fluidic devices by providing an alternative method for the fabrication of fluidic devices at a higher production output and lower cost.

Polydimethylsiloxane (PDMS) is the preferred material for the fabrication of biomedical fluidic devices due to its excellent elasticity, high optical transparency, good biocompatibility, exceptional chemical inertness, and easy material solidification. However, conventional PDMS with a pre-polymer combination of vinyl- and hydride-terminated PDMS is thermally cured via organometallic crosslinking with a platinum catalyst. In parallel with that, conventional PDMS lacks photoinitiator and light-reactive functional groups for photocuring to occur upon UV exposure, making it difficult to fabricate with SLA printing. This is because SLA printing relies heavily on the photocuring of the resin material upon UV exposure to form solid 2D layers that build up to a 3D structure.

Therefore, there is provided a method and system for producing a hydrophilic silicone-based ink and use of the same

### SUMMARY

The disclosure is directed at a novel ink or material for use in three-dimensional (3D) printing. In some embodiments, the novel ink of the disclosure is directed at use in the printing of fluidic devices. In some embodiments, the disclosure includes a combination of a amphiphilic siloxane monomer/oligomer (such as, but not limited to, silmer) and a photoinitiator. In another embodiment, the disclosure further includes a set of at least one crosslink monomers such as, but not limited to, acrylamide (AA) and glycidyl methacrylate (GMA) allowing for the printability and/or mechanical properties of the ink of the disclosure to be fine-tuned.

Furthermore, in a specific embodiment, the amphiphilic siloxane monomer/oligomer, is silmer that is used as a component for the formulation of a hydrophilic silicone-based ink or material designed for the stereolithography (SLA) printing of fluidic devices with embedded channels with complicated geometries.

In another aspect of the disclosure, there is provided a printable material for use in three-dimensional printing including an amphiphilic siloxane monomer/oligomer; and a photoinitiator.

In another aspect, the printable material further includes at least one crosslink monomer. In yet another aspect, the at least one crosslink monomer is acrylamide, glycidyl methacrylate, acrylic acid or (Hydroxyethyl) methacrylate. In yet another aspect, the printable material further includes a solvent for dissolving the amphiphilic siloxane monomer/oligomer. In a further aspect, the solvent is ethanol, ethylene glycol, diethylene glycol, ethylhexanoic acid, dibenzyl ether, water, isopropyl alcohol or a combination thereof.

In another aspect, the printable material further includes a solvent for dissolving the at least one crosslink monomer. In yet another aspect, the solvent is ethanol, ethylene glycol, diethylene glycol, ethylhexanoic acid, dibenzyl ether, ethanol, water, isopropyl alcohol or a combination thereof. In yet a further aspect, the solvent includes ethanol and ethylene glycol. In an aspect, the solvent includes ethanol, ethylene glycol and water. In another aspect, the amphiphilic siloxane monomer/oligomer is silmer and the at least one crosslink monomer includes acrylamide and glycidyl methacrylate. In yet a further aspect, the printable material further includes a solvent including ethanol, ethylene glycol and water for dissolving the silmer, acrylamide and glycidyl methacrylate.

In another aspect of the disclosure, there is provided a method of formulating a printable material for use in three-dimensional printing including mixing an amphiphilic siloxane monomer/oligomer with a photo initiator.

In a further aspect, the method further includes adding at least one crosslink monomer to the amphiphilic siloxane monomer/oligomer and photo initiator mixture. In yet another aspect, the method further includes dissolving the amphiphilic siloxane monomer/oligomer, the photo initiator and at least one crosslink monomer in a solvent to produce a first mixture. In another aspect, the at least one crosslink monomer is glycidyl methacrylate and the solvent is a combination of ethanol and ethylene glycol. In yet another aspect, the method further includes dissolving acrylamide in water to produce a second mixture; and adding the second mixture to the first mixture.

### BRIEF DESCRIPTION OF THE DRAWINGS

The disclosure will be better understood with reference to the attached drawings, in which:

FIG. 1 is a schematic diagram of one embodiment of an ink in accordance with an embodiment of the disclosure;

FIG. 2 is a flowchart showing one method of producing an ink in accordance with an embodiment of the disclosure;

FIG. 3a is a schematic diagram showing the formation of a silmer, acrylamide (AA), and glycidyl methacrylate (GMA) polymer network based on chain growth polymerization upon UV exposure in the presence of diphenyl(2,4,6-trimethylbenzoyl) phosphine oxide (TPO) as the photoinitiator with the chemical structure of silmer, AA, GMA, and TPO shown below their respective legend keys;

FIG. 3b is a set of Fourier Transform Infrared spectroscopy (FTIR) spectra of silmer(S), silmer with AA (S:A), silmer with GMA (S:G), and silmer with AA and GMA (S:A:G) formulated with a respective monomer ratio of S=1, S:A=1:0.05, S:G=1:05, and S:A:G=1:0.025:0.025;

FIG. 4a is a set of photographs showing the pre-gel appearance of silmer when mixed with or dissolved in water, hexane, ethanol, and isopropyl alcohol (IPA) (acting as solvents in 1:1 ratio of silmer to solvent);

FIG. 4b is a chart showing contact angle of cured silmer polymers formulated with a solvent including ethanol mixed with different amphiphilic solvents in a 1:1 solvent ratio;

FIG. 4c is a schematic diagram showing the molecular dynamic simulation on the arrangement of the amphiphilic polymer when being subjected to two different solvent types where the simulated polymer/solvent system includes amphiphilic polymers with PA representing hydrogen atom, PB representing hydrophilic blocks, and PC representing hydrophobic blocks, together with solvent molecules;

FIG. 4d is an FTIR spectra of silmer with ethanol (EtH) and silmer with a mixture of ethanol and ethylene glycol (EG) in a 9:1 ratio showing peaks at 1010 cm⁻¹ and 438 cm⁻¹ representing Si—O—Si stretching and Si—O—Si rocking;

FIG. 5a is a graph showing the effect of increasing ethylene glycol content in the ethanol (EtH):ethylene glycol (EG) solvent blend on the contact angle of the cured polymer;

FIG. 5b is a graph showing the effect of increasing ethylene glycol content in the ethanol (EtH):ethylene glycol (EG) solvent blend on the viscosity of the pre-polymer solution,

FIG. 5c is a graph showing the effect of increasing ethylene glycol content in the ethanol (EtH):ethylene glycol (EG) solvent blend on the optical transmittance of the pre-polymer and cured polymer at 700 nm;

FIG. 5d is a graph showing the effect of increasing ethylene glycol content in the ethanol (EtH):ethylene glycol (EG) solvent blend on the rheological properties of the cured polymer;

FIG. 5e is a graph showing the effect of increasing ethylene glycol content in the ethanol (EtH):ethylene glycol (EG) solvent blend on the curing depth of the composite polymer when dissolute in the EtH:EG solvent blend without (9 EtH:1 EG) and with water (8 EtH:1 EG: 1 H₂O) across a range of exposure times where the composite polymer includes silmer, AA, and GMA in the monomer ratio of 1:0.04:0.01 dissolute in the respective solvent in a 1:1 ratio of silmer to solvent or solvent blends with 3 wt % of TPO added;

FIG. 6a is a graph showing the mechanical properties of a silmer/AA/GMA cured polymer in terms of rheology for the storage modulus, G′, loss modulus, G″, and tan δ, of the silmer/AA/GMA cured polymer;

FIG. 6b is a graph showing the mechanical properties of silmer/AA/GMA cured polymer in terms of compression with varying dosages of AA (A) and GMA (G) with respect to silmer(S) in the monomer ratio of 1S:[xA:yG] in the form of a compressive stress-strain graph;

FIG. 6c is a graph showing the mechanical properties of silmer/AA/GMA cured polymer in terms of compression with varying dosages of AA (A) and GMA (G) with respect to silmer(S) in the monomer ratio of 1S:[xA:yG] with the compressive modulus at 10% and 30%, and the compression at break of silmer/AA/GMA cured polymer;

FIG. 6d is a graph showing the mechanical properties of silmer/AA/GMA cured polymer in terms of tensile strength with varying dosages of AA (A) and GMA (G) with respect to silmer(S) in the monomer ratio of 1S:[xA:yG] in the form of a tensile stress-strain curve;

FIG. 6e is a graph showing the mechanical properties of silmer/AA/GMA cured polymer in terms of the tensile modulus at 10% and 30%, and the elongation at break of silmer/AA/GMA cured polymer;

FIG. 7a is a graph showing the chemical compatibility and biocompatibility properties of the silmer/AA/GMA cured polymer with respect to the swelling degree of silmer/AA/GMA cured polymer compared against Sylgard 184 and a hydrophilic silicone material with different solvents upon 24 hours of incubation;

FIG. 7b is a set of photographs showing the appearance of silmer/AA/GMA cured polymer with a monomer ratio of 1:0.04:0.01 after 24 hours of incubation in different solvents;

FIG. 7c shows relative cell viability of silmer/AA/GMA polymer at Day 4 with the respective light microscope images of cells after staining with MTT indicator taken at 10× magnification;

FIG. 8a shows the printing properties of silmer/AA/GMA polymer with respect to the gel point of silmer/AA/GMA polymer with different AA to GMA monomer ratios with respect to 1 part of silmer;

FIG. 8b shows the printing properties of silmer/AA/GMA polymer with respect to the transparent printed structure with microscope images showing the layer-by-layer structure;

FIGS. 8c to 8e show the printing properties of silmer/AA/GMA polymer with respect to the printing resolution of the channel width;

FIGS. 8f to 8h show the printing properties of silmer/AA/GMA polymer with respect to channel height of the silmer/AA/GMA polymer with different dosages of yellow dye (YD);

FIG. 9a shows the printing of embedded channel fluidic devices with a silmer/AA/GMA polymer with respect to the printing of a serpentine channel with the top view and side view showing the features of the printed embedded channel;

FIG. 9b shows the printing of embedded channel fluidic devices with silmer/AA/GMA polymer with respect to the printing of fluidic devices with multiple geometries functioning as parallel lamination mixer, barrier structure mixer, deterministic lateral displacement (DLD) separator, and channels with wells flowed with red and blue dye;

FIG. 10a shows the functionality of the printed fluidic devices when subjected to static flow at different temperatures up to 24 hours;

FIG. 10b shows the functionality of the printed fluidic devices when subjected to dynamic flow with the flow of blue dye followed by red dye for the demonstration of continuous fluid flow;

FIG. 11a shows the synthesis of drug-encapsulated hydrogel beads directed at the setup of the printed fluidic mixing device for the synthesis of drug-encapsulated hydrogel beads;

FIG. 11b are microscope images showing the mixing of gelatin and FITC-amoxicillin drug solution within the parallel lamination mixer with serpentine channel;

FIG. 11c is a microscope image of the FITC-amoxicillin drug-encapsulated gelatin hydrogel beads; and

FIG. 12 is a table showing the molecular formula and molecular weight of solvents used in chemical compatibility tests.

### DETAILED DESCRIPTION

The disclosure is directed at a method and system for producing a hydrophilic silicone-based ink and use of the same. In some embodiments the disclosure includes an amphiphilic siloxane monomer/oligomer along with a photoinitiator. In other embodiments, the disclosure further includes at least one crosslink monomer such as, but not limited to, acrylamide (AA) and glycidyl methacrylate (GMA). Use of the disclosure facilitates the printing of fluidic devices with microfluidic channels having complicated geometries. In some embodiments, the disclosure is used for different types of three-dimensional (3D) printing, such as, but not limited to, stereolithography (SLA) printing.

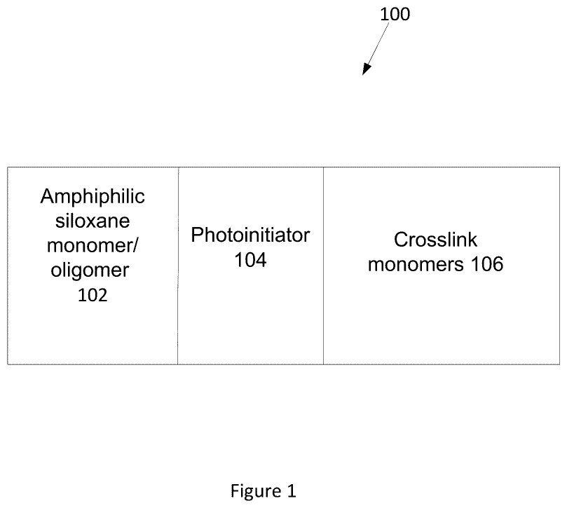

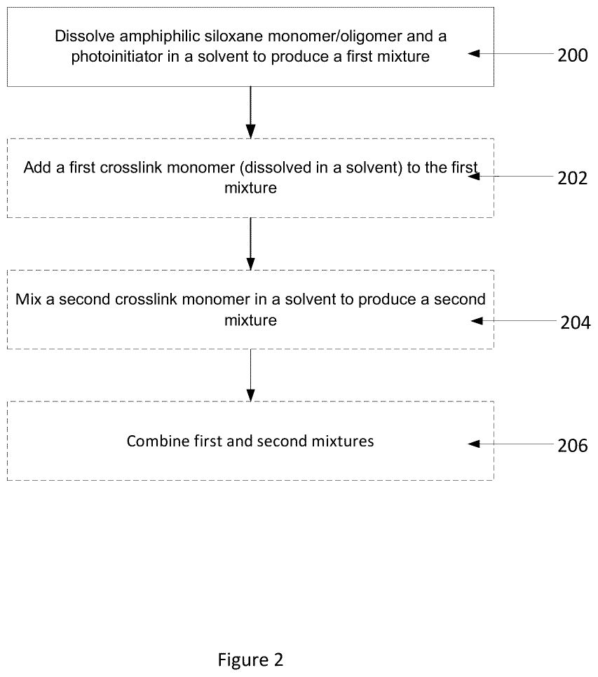

Turning to FIG. 1, a schematic diagram of an ink in accordance with the current disclosure is shown. In the current embodiment, the ink 100 includes an amphiphilic siloxane monomer/oligomer 102 in combination with a photo initiator 104 and at least one crosslink monomer (106). Depending on the application or use of the ink, in some embodiments there may not be a need for crosslink monomers. Examples of crosslink monomers include, but are not limited to, acrylamide (AA), glycidyl methacrylate (GMA), acrylic acid or (Hydroxyethyl) methacrylate. One example of an amphiphilic siloxane monomer/oligomer may be a hydrophilic monomer/oligomer silioxane diacrylate or silmer. In some embodiments, the different components of the ink are dissolved in solvents during its manufacture or production. This is discussed in more detail with respect to FIG. 2.

FIG. 2 is a flowchart showing one method of producing a hydrophilic silicone-based ink. Initially, an amphiphilic siloxane monomer/oligomer and a photoinitiator are mixed or dissolved in a solvent (200). This may be seen as a first mixture. In one specific embodiment, the amphiphilic siloxane monomer/oligomer is silmer and the solvent is ethanol. In other embodiments, the solvent may be a combination of ethanol and ethylene glycol. While different ratios may be contemplated, in one embodiment, the ethanol and ethylene glycol is in a 1:1 ratio.

In some embodiments, depending on a final use of the hydrophilic silicone-based ink i.e. the structure that the ink is being used to three-dimensional (3D) print, a crosslink monomer, such as, but not limited to, GMA is dissolved in a solvent and then added to the first mixture (202). In one embodiment, the solvent is ethylene glycol. In some embodiments, (200) and (202) may be combined such that the amphiphilic siloxane monomer/oligomer, the photoinitiator and the crosslink monomer, such as GMA, are mixed or dissolved in a solvent of ethanol and ethylene glycol or any other suitable solvent mixture depending on a final use of the ink of the disclosure to produce the first mixture.

Again, depending on the final use of the ink of the disclosure, a second crosslink monomer, such as but not limited to, AA may be mixed with or dissolved in another solvent (204) such as, but not limited to water, to produce a second mixture.

In some embodiments, the crosslink monomers may be mixed or dissolved together with the amphiphilic siloxane monomer/oligomer and photoinitiator in a single solvent or container. In some embodiments, the solvent may include a combination of ethanol, ethylene glycol and water when the ink components include silmer, the photoinitator, GMA and AA.

If the AA and solvent are mixed separately from the first mixture, the second, or AA, mixture is then combined with the first mixture (206). As will be understood, (202), (204) and (206) are shown in dotted lines as they may or may not be necessary in each embodiment of the ink of the disclosure but in a specific embodiment, as disclosed below, the method includes each of (200) to (206).

Further details with respect to specific examples of components of the ink of the disclosure are discussed below. It is understood that the components taught are examples only and not meant to be restrictive.

In one embodiment of the method shown in FIG. 2, silmer was dispersed in a solvent mixture including ethanol, ethylene glycol, and water followed by the addition of AA and GMA monomers acting as crosslink monomers. The mixture or solution also includes photoinitator, such as, but not limited to, TPO. In experiments, different solvent mixtures were prepared with varying ratios of ethanol, ethylene glycol, and water prepared based on the formulation amount of silmer, AA and GMA.

The silmer was then dispersed or dissolved in the solvent mixture with a 1 to 1 ratio at room temperature (22±2° C.) until a homogeneous mixture was obtained. After that, a varying dosage of AA and GMA with a ratio ranging from 0.04:0.01 to 0.01:0.04 with respect to silmer was added into the pre-gel solution (or first mixture) and stirred at room temperature (22±2° C.) until complete dissolution. Finally, 3 wt % of TPO was added and stirred at room temperature for 1 hour in the dark before proceeding with printing. The dosage in wt % was calculated based on the total monomer content of the pre-gel solution.

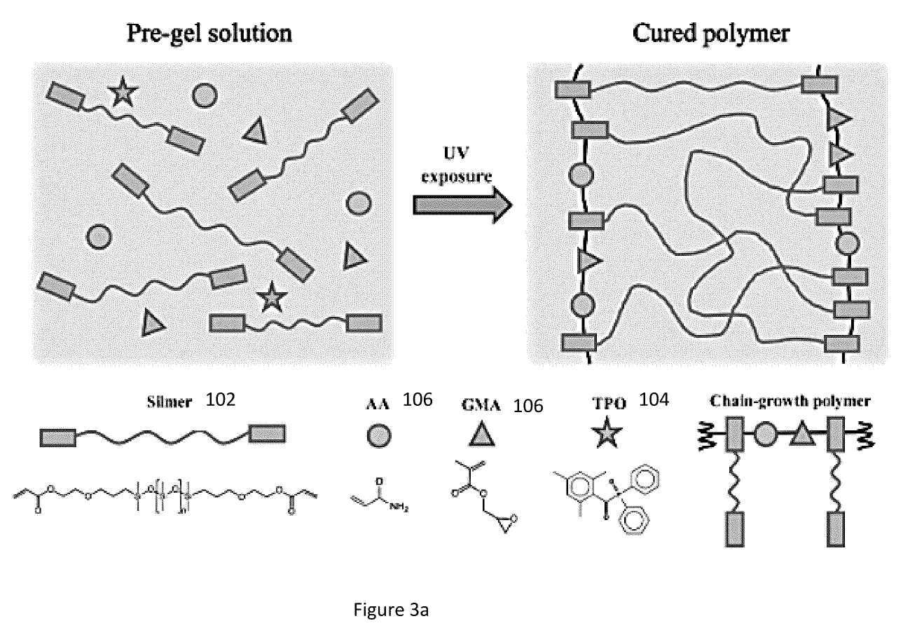

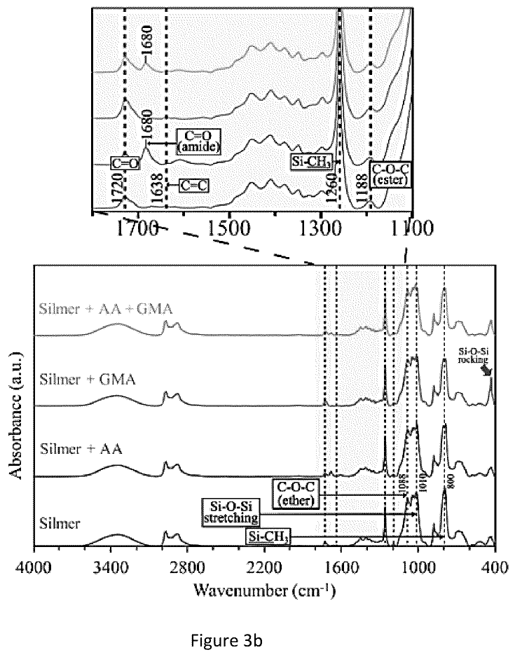

In another specific embodiment, the components of the ink include silmer, AA, GMA and a photoinitiator, each of which are dissolved in a solvent. In this embodiment, the silmer is an amphiphilic siloxane oligomer with an A-B-A linear chain arrangement of PEGMA-siloxane-PEGMA (schematically shown in FIG. 3a), for which PEGMA and siloxane contribute to the hydrophilic and hydrophobic properties of silmer, respectively. In testing of this specific embodiment, based on the average molecular weight of 2,800 g/mol, the siloxane chain was calculated to have an average chain length of about 33 to 34 Si—O monomer units.

Fourier Transform Infrared Spectroscopy (FTIR) characterization of the silmer confirmed the presence of siloxane chains in the silmer with the emergence of peaks at 1260, 1010, and 800 cm⁻¹ representing Si—CH₃, Si—O—Si, and Si—CH₃, accordingly as schematically shown in FIG. 3b. The presence of the PEGMA group in silmer was confirmed via the presence of peaks at 1720, 1638, 1188, and 1088 cm⁻¹ representing the C═O, C═C, C—O—C in ester, and C—O—C in ether, respectively. Among the functional groups mentioned, the presence of the C═C bond of the methacrylate group in PEGMA is necessary for the formation of a crosslinked silicone polymer network upon photoinitiation as the C═C bond serves as the growth point for polymerization owing to its ability to form radicals for chain-growth polymerization upon initiation. Therefore, due to the presence of growth points at both ends, silmer is often included to form branches connecting linear polymer chains for a crosslinked polymer network.

In determining the use of silmer as a component for embodiments of the ink of the disclosure, the utilization of silmer as the major monomer composition for the formulation of a hydrophilic silicone-based polymer network or ink was contemplated. It was determined that silmer has a comparatively slow curing rate when used solely with a high amount of a photoinitiator (˜10 wt %) required for rapid photocuring. Although the combination of silmer and the photoinitiator can produce an ink in accordance with the disclosure, in the specific embodiment, further components are added in order to further improve the characteristics of the ink.

For example, as the slow photocuring rate of silmer might be due to the presence of less reactive side groups that hinders the formation of silmer radicals at the growth point, additional monomers with improved reactivity in radical formation may be included as components in embodiments of the ink to enhance the overall photocuring speed of a silmer polymer network. More specifically, acrylamide (AA) monomers were added to the ink as these monomers polymerize quickly upon photoinitiation due to the presence of its amide side group in favoring the formation of AA radicals as schematically shown in FIG. 3a. Additionally, AA is a common building block for hydrophilic polymers intended for biomedical use, which allows the ink of the disclosure to be used to print 3D structures for use in biomedical applications.

As such, in one specific embodiment, AA was selected for inclusion into the silmer polymer system or ink to elevate or accelerate the overall photocuring speed of the silmer polymer network. The further inclusion of AA into the silmer polymer network was characterized by the emergence of an FTIR peak at 1680 cm⁻¹ representing the C═O of the amide group as schematically shown in FIG. 3b. It is understood that in some embodiments, the ink may not include AA monomers.

Despite the faster photocuring speed upon the inclusion of AA, in some embodiments, there may be a requirement for the ink to have elasticity. In addressing this, one specific embodiment of the ink of the disclosure includes GMA as another monomer to assist in inducing a slight disorder in the highly packed silmer/AA polymer network with the presence of its epoxy side group as schematically shown in FIG. 3a. The slight disruption in the highly ordered arrangement of the dense polymer network allows the polymer chains to slide past each other more easily, leading to an increase in elasticity and flexibility of the ink when used to print a structure. The interruption of the highly packed silmer/AA polymer network with GMA is further evidenced by the emergence of a peak at 438 cm⁻¹ representing Si—O—Si rocking upon the addition of GMA as the emergence of Si—O—Si rocking indicates the change in siloxane chain in the presence of GMA as schematically shown in FIG. 3b. Thus, aside from elevating the photocuring speed, the incorporation of additional monomers enables the altering of the polymer network arrangement, and therefore the mechanical properties of the final polymer material or ink, offering the flexibility to fine-tune polymer characteristics by varying the monomer composition. In other embodiments, monomers other than AA and/or GMA may be contemplated.

In preparing the ink of the disclosure, there is a need for the dissolution of the components in a solvent for the formulation of a pre-gel solution. Although specific materials or components are described with respect to a specific embodiment of the disclosure, it is understood that other similar materials may be substituted.

In the specific embodiment of the ink of the disclosure for use in the printing of fluidic devices, as silmer is a larger component of the silicone polymer network, the selection of the solvent for use in monomer dissolution of the components may be driven by the best solvent for the dissolution of silmer. However, the selected solvent was also tested against AA and GMA to ensure the complete dissolution of all components for a homogeneous distribution of the monomers within the pre-gel solution or the ink of the disclosure. Due to the nature of silmer being an oligomer, the behavior of silmer aligns more closely with polymers rather than individual monomers when exposed to solvents. Generally, the arrangement of polymers in the solvent depends highly on their interaction with the surrounding solvent molecules. Consequently, when a suitable solvent is used, the polymer chains expand due to polymer-solvent interactions, resulting in a clear solution appearance. Therefore, the choice of a more suitable solvent to facilitate the expansion of silmer within the solvent will result in a clear solution appearance.

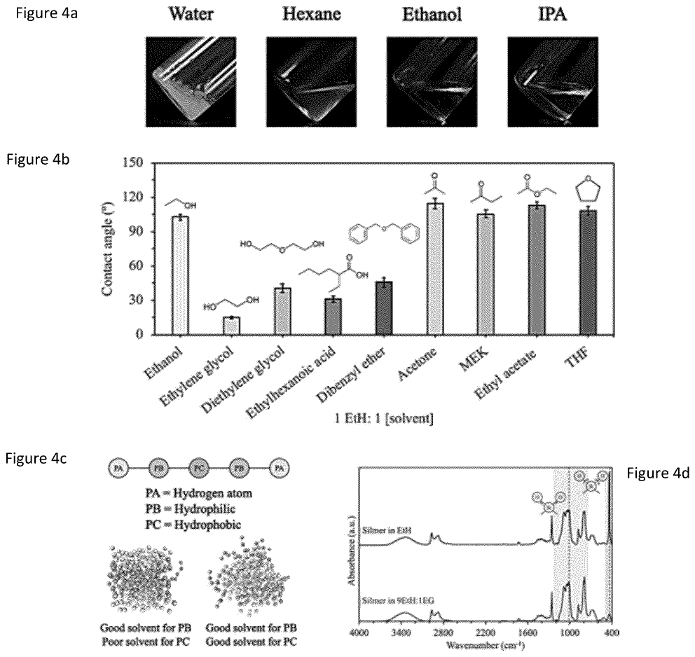

Turning to FIG. 4a, which are photographs of silmer being mixed with different solvents, it was determined that mixing or dissolving silmer in either ethanol or isopropyl alcohol (IPA) provided a clear appearance in the solution. This is likely attributed to the interaction between silmer and the amphiphilic solvent molecules due to their similarity in chemical composition. Conversely, silmer was observed to exhibit an opaque appearance when dissolved in water, which is most likely due to the inability of the highly hydrophilic water molecules to interact with the hydrophobic section of the amphiphilic silmer, leading to the formation of silmer aggregates. Additionally, it was noted that the pre-gel viscosity of silmer exhibited a substantial rise, resulting in the formation of a gel-like consistency, upon dissolution in water. The increase in pre-gel viscosity rules out water alone as a choice of solvent when used solely for silmer dissolution as SLA printing prefers ink with low pre-gel viscosity. However, in other embodiments of the ink of the disclosure, water may be selected as a solvent for the dissolution of monomers.

Depending on the use or desired final properties of the ink of the disclosure, the silmer can be dissolved in any solvent but preferably IPA or ethanol. If used in the printing of a 3D fluidics structure, in order to provide a clear interface for fluidics application, the silicone ink containing silmer was formulated or dissolved with amphiphilic solvents, such as, but not limited to, ethanol, for a clear pre-gel solution.

For use in the 3D printing of a microfluidics or fluidics device, besides having a clear device interface, it may be desired that the final printed structure includes hydrophilic surface properties to cope with the aqueous solutions used for biomedical applications. Typically, polymers with a contact angle below 90° are regarded as hydrophilic, while those with a contact angle above 90° are considered to have hydrophobic surface properties. As shown in FIG. 4b, despite the presence of hydrophilic PEGMA groups in silmer, the cured silmer polymer formulated with ethanol was found to have hydrophobic surface properties with a contact angle of about 102.6±3.0°. It is understood that solvents with different solvent qualities can induce conformational changes in amphiphilic polymers, and thus, possibly altering the surface properties of the amphiphilic polymer by varying the proportion of polar and non-polar groups on the surface of the polymer. Therefore, instead of dissolving the components in a single solvent, a combination of amphiphilic solvents were considered in a 1:1 ratio mix with ethanol to further alter the surface properties of silmer to include a higher portion of PEGMA groups on the silmer polymer surface to improve hydrophilic surface properties.

It was determined that different solvents, such as ethylene glycol, diethylene glycol, ethylhexanoic acid, and dibenzyl ether mixed or incorporated with ethanol were helpful to aid in the formation of silmer polymer with hydrophilic surfaces as schematically shown in FIG. 4b. However, silmer that was prepared using a combination of ethanol with acetone, methyl ethyl ketone (MEK), ethyl acetate, and tetrahydrofuran (THF) were observed to retain their hydrophobic properties which may be beneficial for some printing 3D applications but not for the printing of a fluidic device. Molecular dynamic simulation suggests that solvents that facilitate the creation of hydrophilic surfaces may possess unique solvent properties in relation to the polar and non-polar components of silmer. Specifically, these solvents exhibit characteristics of being a low-quality solvent for hydrophobic siloxane chains, while being a high-quality solvent for the hydrophilic PEGMA groups such as schematically shown in FIG. 4c. As such, the amphiphilic polymer results in a conformation where the hydrophobic section is sandwiched between the hydrophilic groups as the solvent favors interaction with the hydrophilic groups and not the hydrophobic groups. In contrast, the use of an equally good solvent for both the polar and non-polar composition of silmer encourages the random arrangement of silmer as there is no formation of polymer aggregates. Subsequently, the initially higher composition of the siloxane chain than the PEGMA group in silmer further contributes to the hydrophobic surface properties when arranged randomly. The change in silmer conformation with solvent is further evidenced by the FTIR spectra shown in FIG. 4d. Upon the inclusion of ethylene glycol to the ethanol solvent, the absorbance at 1010 cm⁻¹ representing Si—O—Si stretching increased with a significant reduction in the absorbance at 438 cm⁻¹ representing Si—O—Si rocking. The significant reduction in Si—O—Si rocking implies the collapse of the siloxane chains upon the inclusion of ethylene glycol, which aligns with the molecular dynamic simulation where the siloxane chains fold compactly to form distinct layers of polymer with hydrophobic siloxane chains being sandwiched between the hydrophilic PEGMA groups. Therefore, it can be seen that the change in solvent can alter the silmer conformation for a change in surface properties. Additionally, the inclusion of a poor solvent with respect to hydrophobic groups can help structure the hydrophilic groups of the silmer to the surface of the cured polymer for hydrophilic surface properties. Among the solvents investigated, ethylene glycol was found to generate the most hydrophilic surface with a contact angle of about 14.8±0.9° when mixed with ethanol as schematically shown in FIG. 4b and was selected to be combined with ethanol to dissolve the components of the specific embodiment of the ink of the disclosure to be used for the printing of fluidic devices.

Prior to the determination of the solvent ratio, a monomer ratio of silmer, AA, and GMA of 1:0.04:0.01 was selected to proceed with a determination of one embodiment of a solvent ratio. The solvent ratio determination in relation to the monomer ratio is discussed in further detail below.

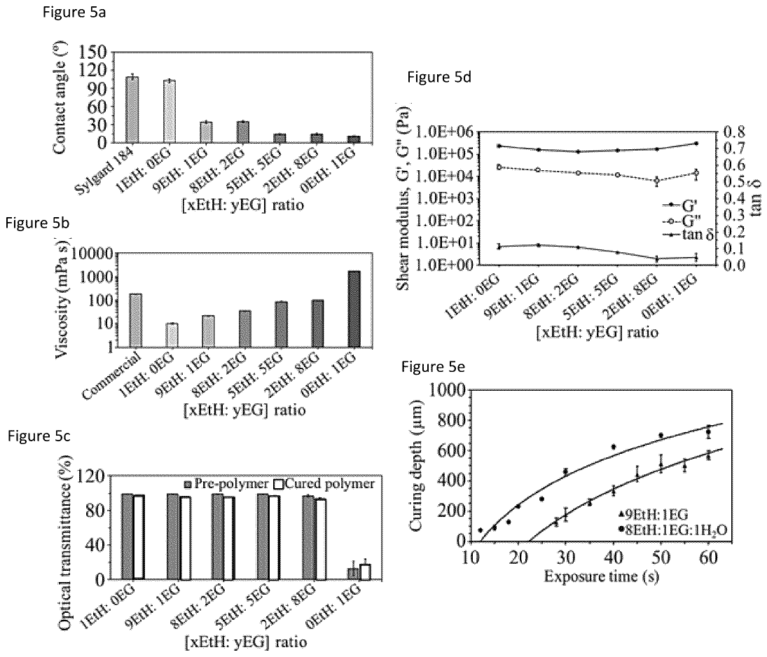

Based on the graph of FIG. 5a, the contact angle of silmer was found to lower from about 34.5±2.3 to about 14.8±1.9° as the ethylene glycol (EG) content in the solvent mixture increased relative to ethanol (EtH) from 9 EtH:1 EG to 2 EtH:8 EG, accordingly. The contact angle of silmer was observed to further reduce down to about 11.2±1.1° with the use of EG only as the solvent. This stands in contrast to the hydrophobic surface properties of conventional PDMS material as reflected by the contact angle at about 109.3±4.9°. However, the pre-gel viscosity was found to increase with the increasing content or amount of EG, making it less desirable for SLA printing such as schematically shown in FIG. 5b. Furthermore, the increase in EG content results in a slight reduction in the transparency of both the pre-gel solution and cured polymer, with the effect being amplified when formulated solely with EG as the solvent, leading to an opaque appearance with about 12.9±8.4% and about 17.6±6.5% of light transmitted through the pre-gel solution and cured polymer, respectively, as shown in FIG. 5c. The increase in pre-gel viscosity and reduction in transparency with EG further implies EG alone is a poor solvent for use in the specific embodiment with respect to the hydrophobic siloxane chain, which causes the formation of an increased amount of silmer aggregates as reflected by the opaque appearance of both the pre-gel solution and cured polymer. As indicated previously, silmer aggregation is necessary for the organization of hydrophilic groups to the surface of cured silmer polymer to provide hydrophilic surface qualities in the final printed 3D structure. Therefore, it is important to only induce a predetermined amount of silmer aggregation for the generation of hydrophilic surfaces while maintaining the transparent appearance and low pre-gel viscosity of the formulated ink or printing material.

The effect of EG content on the rheological properties of the silmer/AA/GMA polymer was investigated as schematically shown in FIG. 5d. The silmer/AA/GMA polymer was revealed to increase in stiffness with the EG content. This is reflected by the values of tan δapproaching 0 as the loss modulus (G″) representing the viscous component in the viscoelastic material reduces steadily with the increasing EG content. Based on these experiments, in a specific embodiment, a solvent mixture of 9 EtH:1 EG was used for the generation of cured silmer polymer with hydrophilic surfaces.

Despite achieving the targeted properties, the pre-gel solution formulated with 9 EtH:1 EG was observed to have relatively slow photocuring properties as solvent plays a role in affecting the rate of free radical polymerization of monomers. For instance, N,N-dimethylacrylamide was revealed to have a 2.7 and 8.5 times slower polymerization rate when formulated with ethylene glycol and methanol as the solvent, respectively, instead of water. This aligns with the slow polymerization rate of a silmer pre-gel solution containing AA and GMA monomers when formulated with the 9 EtH:1 EG solvent mixture. As AA monomers demonstrate a higher reactivity than silmer and GMA for polymerization due to the nature of its side group, a further component may be added to the solvent formulation or the AA may be dissolved separately from the dissolution of silmer and GMA in the 9 EtH:1 EG solvent mixture and then added to the mixture.

Therefore, in order to in order to increase the overall polymerization rate of the silmer pre-gel solution, the polymerization rate of AA monomer was investigated. Since AA and methacrylamide (MAA) monomers are found to polymerize quickly in the presence of water, it was determined that the use of water in the dissolution of the AA monomers would be beneficial to generating some embodiments of the ink of the disclosure. Specifically, the water molecules were found to aid in the expansion of the bond-forming group as the water molecules formed hydrogen bonding with both the carbonyl (—C═O) and amino (—NH₂) groups of the respective monomers. Upon the expansion of the bond-forming group, both AA and MAA can polymerize more rapidly as the bond-forming group gains increases exposure to the surrounding medium for better access to monomers for polymerization.

As shown in FIG. 5e, the addition of 1 part of water to the EtH:EG solvent mixture was found to increase the curing rate significantly with the overall curve of curing depth against exposure time shifting towards the left, demonstrating a shorter exposure time required for a designated curing depth. Despite the increase in curing rate with the ratio of water included, further addition of water was observed to elevate the pre-gel viscosity and reduce transparency, which aligns with the observation made on silmer with water alone in FIG. 4a. In another specific embodiment, a final solvent ratio of 8 EtH:1 EG: 1 H₂O was used for the dissolution of the components of the ink of the disclosure to produce an ink with a relatively fast curing rate without severely impacting the other targeted properties of the silmer pre-gel solution and cured polymer.

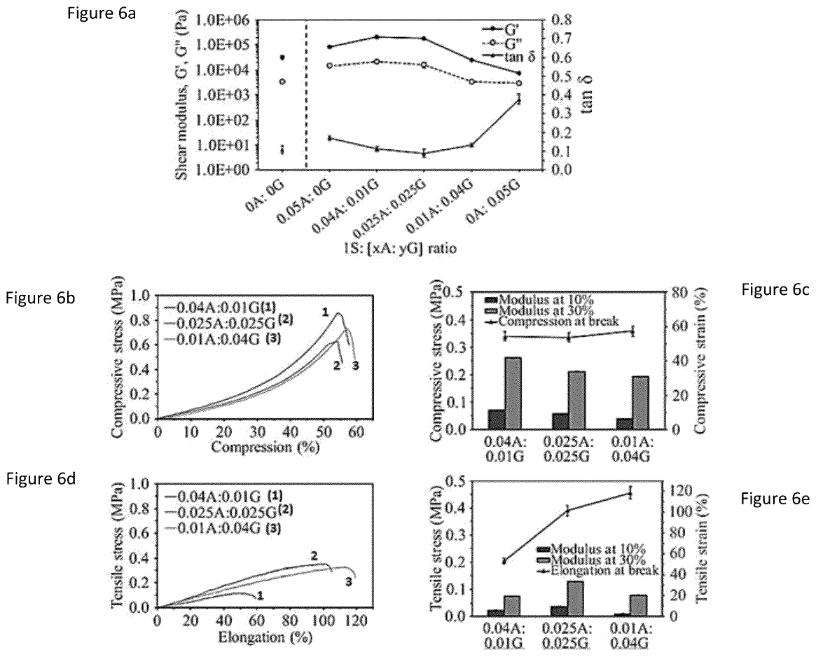

With respect to the monomer ratio effect on cured polymer properties, as schematically shown in FIG. 6a, the silmer polymer was revealed to have elastomeric properties resembling that of viscoelastic solids as reflected by the higher storage modulus (G′) as opposed to the loss modulus (G″) obtained for all the respective samples, regardless of the dosage or amount of AA and GMA. Upon the sole inclusion of 0.05 part of AA to 1 part of silmer, the silmer polymer was observed to have an increase in strength as reflected by the proportional increase in G′ and G″ (FIG. 6a). This shows the role of AA in imparting strength to the silmer polymer due to the ability of AA to increase the crosslinking density within the silmer polymer network. Further incorporation of GMA in small proportion with respect to AA (0.04 AA:0.01 GMA) was found to aid in improving the elasticity of silmer polymer as demonstrated by the slight drop in tan δ, which indicates the increase in elastic component (G′) with respect to viscous component (G″), as tan Õ represents the ratio of G″:G′. The similar rheological profile of silmer polymer with an equal proportion of AA and GMA (0.025 AA:0.025 GMA) further confirms the role of GMA in imparting elasticity to the silmer polymer. These observations on the rheological properties of silmer polymer upon the incorporation of GMA support the understanding of GMA in improving the elasticity of the silmer polymer network by interfering with the arrangement of the highly packed silmer polymer network as evidenced by the FTIR spectrum in FIG. 3b. However, the further increase in GMA with respect to AA (0.01 AA:0.04 GMA) was shown to result in a silmer polymer with low strength and less elasticity as implied by the drop in G′ and G″ followed by the reduction in elastic component represented by the rise in tan δ, respectively (FIG. 6a). The sharp drop in G′ and G″ along with the surge in tan δupon the sole inclusion of 0.05 part GMA to 1 part of silmer further suggests that a high dose of GMA would result in a weak silmer polymer. As such, the GMA should be incorporated in small amounts with respect to AA for the best results in terms of rheological properties. As shown in FIG. 6a, both silmer with an additional monomer ratio of 0.04 AA:0.01 GMA and 0.025 AA:0.025 GMA appear to be within the range for the formulation of a silicone-based polymer with suitable strength and elasticity for use in printing fluidic devices as reflected by the relatively high G′ and G″, and the low tan δvalue, accordingly.

Next, with respect to the compression and tensile properties of silmer/AA/GMA polymers with different AA and GMA monomer ratios relative to silmer. Based on graphs shown in FIGS. 6b and 6c, the gradual reduction in compressive modulus at 10% and 30% with the decreasing content of AA with respect to GMA confirms the role of AA in imparting strength. As shown, the compression at break of the silmer/AA/GMA polymer remains comparatively similar within the range of 54 to 57%, regardless of the AA and GMA monomer ratio. This suggests that the compressibility of the silmer/AA/GMA polymer is largely influenced by the constant silmer content within the polymer, with the amount of both AA and GMA being too small to significantly influence the compressibility of the silmer/AA/GMA polymer. On the other hand, the varying AA to GMA monomer ratio with respect to silmer was observed to have a significant impact on the elasticity of the silmer/AA/GMA polymer as reflected by the increase in elongation at break from about 53 to about 118% as the GMA content increases from 0.01 to 0.04 with respect to 0.04 to 0.01 part of AA (as shown in FIGS. 6d and 6e). This aligns closely with all the previous analyses regarding the role of GMA in imparting elasticity to the silmer polymer upon its inclusion. As for the AA monomer, a high AA content relative to GMA (0.04 AA:0.01 GMA) was observed to produce a relatively brittle silmer polymer, resulting in a lower tensile modulus that stands out as an outlier among the three sets of samples. Further increase in GMA content from 0.025 to 0.04 part with respect to the reduction in AA content from 0.025 to 0.01 part, respectively, was found to result in a gradual reduction in tensile modulus, which closely resembles the trend observed for compressive moduli. In general, the change in AA: GMA monomer ratio with respect to silmer has no significant impact on the hydrophilicity, viscosity, and transparency of the silmer/AA/GMA polymer. As understood, high elasticity is not always a necessary material characteristic for fluid processibility when fabricating fluidic devices with the developed material. Therefore, when considering the formulation of silmer/AA/GMA polymer for the SLA printing of fluidic devices, it is important to understand that a final polymer material with sufficient strength and elasticity to withstand the required fluid pressure is adequate for the fabrication of fluidic device with effective fluid processibility. In experiments, it was determined that for the printing of fluidic devices, an ink having silmer in the range of about 50 to about 70 wt %, AA from about 10 to about 25 wt %, and GMA from about 10 to about 25 wt %, with optimal performance observed at approximately 60:20:20 wt % respectively and with respect to each other. In some embodiments, the photinitiator is about 3% wt % of the ink thereby slightly affecting the ratio to the ink components. It is understood that the ranges provided with respect to the silmer, AA, GMA and photoinitator equals 100% for each embodiment of the ink.

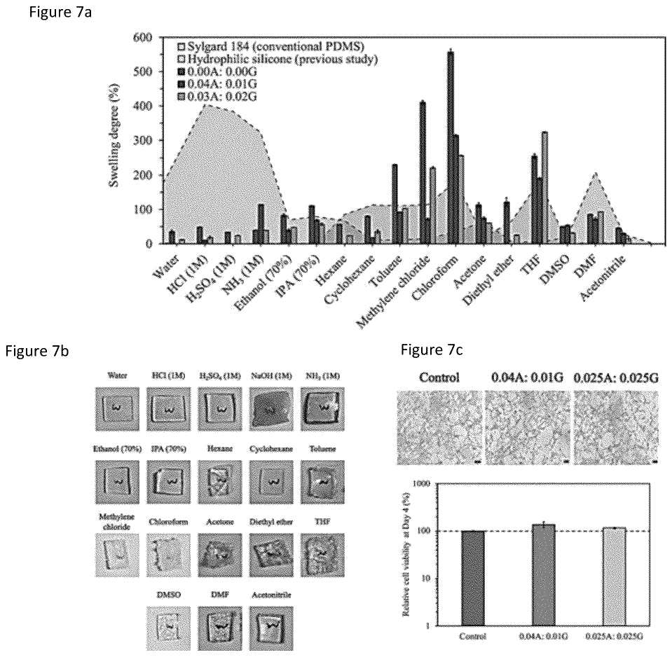

As for the chemical compatibility properties, the silmer/AA/GMA polymer was evaluated in terms of swelling degree against a variety of polar and non-polar solvents for up to 24 hours. As shown in FIG. 7a, the silmer polymer had a lower swelling degree for most solvents upon the inclusion of AA and GMA monomers, except for ammonia and tetrahydrofuran (THF). The lower swelling degree of silmer polymer upon the inclusion of AA and GMA is due to the increase in crosslinking density with AA and GMA monomers. This is because an increase in crosslinking density often indicates an increase in the number of crosslinking points connecting the polymer chains, which in turn, helps restrict or reduce the expansion of the crosslinked polymer, resulting in less swelling when exposed to solvents for an extended period of time. When a high AA content (0.04 AA:0.01 GMA) is employed, the strong presence of the amine group in AA encourages the absorption of ammonia sharing the same amine structure. Similarly, with the increasing GMA content (0.03 AA:0.02 GMA), the stronger presence of the cyclic ether group in GMA encourages the absorption of THE sharing the identical cyclic structure. Furthermore, the inclusion of a high AA content (0.04 AA:0.01 GMA) demonstrated an improved chemical resistance towards most of the solvent, with the exception for isopropyl alcohol (IPA), chloroform, acetone, dimethyl sulfoxide (DMSO), and acetonitrile, for which an increase in GMA content (0.03 AA:0.02 GMA) has a better chemical resistance towards the mentioned solvents as shown in FIG. 7a. Interestingly, the mentioned solvents demonstrating a higher reduction in swelling degree with increasing GMA content (0.03 AA:0.02 GMA) were observed to have a similar chemical structure with a single functional group differing from the remaining two or three functional groups attaching to the fully occupied central carbon atom. The increased resistance to solvent molecules with a fully occupied central carbon consisting of a singular distinct functional group may have been caused, in part, by the cyclic ether in GMA. However, the chemical resistance towards the range of solvent tested does not vary much with respect to the AA: GMA ratio, with the exception of chlorine-containing organic solvents, where a higher AA content results in a 4-fold decrease in swelling with methylene chloride while an increasing GMA content results in a 1.5-fold decrease in swelling with chloroform.

In general, the silmer/AA/GMA polymer demonstrates a similar chemical compatibility profile as the conventional hydrophobic PDMS material, regardless of the monomer ratio of AA: GMA (as schematically shown in FIG. 7a). The silmer/AA/GMA polymer was found to have improved resistance towards polar solvents in comparison to non-polar solvents as reflected by its lower swelling degree with polar solvents as opposed to non-polar solvents. This is likely due to the higher proportion of hydrophobic siloxane chains compared to the combined presence of hydrophilic groups contributed by the PEGMA group, AA monomer, and GMA monomer in the overall silmer/AA/GMA polymer.

Aside from the swelling degree, the appearance of the silmer/AA/GMA polymer after subjecting to solvent swelling was investigated. As shown in FIG. 7b, the silmer/AA/GMA polymer was revealed to have good compatibility with acid as reflected by the clear interface of the polymer after being exposed to hydrochloric acid and sulfuric acid. This is in line with the low swelling degree of the polymer when subjected to acid as illustrated by FIG. 7a. On the contrary, despite the relatively low swelling degree with base, the silmer/AA/GMA polymer was found to discolor with base as demonstrated by its pinkish-brown appearance upon exposure to sodium hydroxide and ammonia for a prolonged period as somewhat shown in FIG. 7b. This implies that the silmer/AA/GMA polymer might not be suitable to be used with basic solutions for a prolonged period as polymer discoloration often indicates polymer degradation.

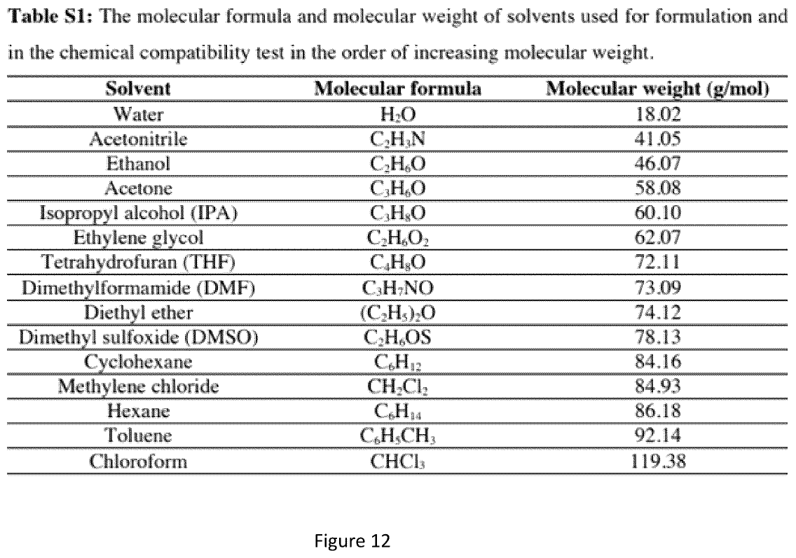

The silmer/AA/GMA polymer was found to rapidly form a network of surface cracks upon removal from certain organic solvents. The formation of surface cracks upon removal from organic solvent is a known phenomenon with solvent-based polymer and is known as solvent crazing. This phenomenon is attributed to the evaporation, or desorption, of solvent from the polymer surface. The evaporation of solvent from the polymer surface generates tensile stress close to the polymer surface, which when it reaches or exceeds the critical stress required to initiate surface cracks, cause cracks to form on the surface of the polymer. Also, the molecular weight of the solvent molecule is a factor in surface crack development as the solvent molecules may disperse into the polymer and possibly supplant the existing solvent molecules as the polymer swells. Thus, higher-molecular-weight solvent molecules would extend the space that lower-molecular-weight solvent molecules formerly occupied, putting the polymer under tensile stress that could further encourage surface crack formation. This aligns with the observation on the clear appearance of silmer/AA/GMA polymer without any crack formed when being subjected to solvents with a lower molecular weight, namely water, ethanol, IPA, and acetonitrile, than the EtH:EG: water solvent used for the ink formulation. The table in FIG. 12 shows the molecular formula and molecular weight of solvents used in chemical compatibility tests. Solvents with a higher molecular weight than the EtH:EG: water solvent used for ink formulation, such as hexane, methylene chloride, chloroform, diethyl ether, and THF, were discovered to induce surface crack on the silmer/AA/GMA polymer upon removal from the soaking medium. However, silmer/AA/GMA polymer was observed to retain its clear interface without cracks with cyclohexane, toluene, DMSO, and dimethylformamide (DMF), despite the higher molecular weight of the solvent mentioned as opposed to the solvent used for ink formulation. This might be due to the possible reaction between the silmer/AA/GMA polymer and the mentioned solvents, which helps retain the solvent molecules within the polymer matrix to prevent or reduce the formation of stress-induced localized crack upon rapid solvent desorption from the polymer surface. Upon comparison, both cyclohexane and toluene were found to have similarities in terms of cyclic functional groups. As for DMSO and DMF, both of these solvents were revealed to have similarities in terms of carbonyl functional group. Additionally, despite the absence of surface crack, the silmer/AA/GMA polymer developed an uneven polymer surface covered with a droplet-like pattern upon removal from DMSO and DMF. In contrast, acetone with a similar carbonyl functional group identical to DMSO and DMF was revealed to induce surface crack on silmer/AA/GMA polymer upon removal from the soaking medium. This might be attributed to the relatively low molecular weight of acetone as compared to DMSO and DMF, which fails to remain in the polymer matrix for a slower desorption rate. In general, all three sets of silmer/AA/GMA polymer with varying AA: GMA dosages were revealed to display the same appearance after subjecting to swelling with the range of tested solvents. Thus, it can be concluded that the occurrence of solvent crazing is most likely attributed to the reaction between the silmer and the solvent molecules, with little impact contributed by the minor composition of AA and GMA. Since the silmer/AA/GMA polymer exhibits no surface cracks and a relatively low swelling degree after being exposed to water, ethanol, and IPA further implies the high suitability of the specific embodiment of the ink of the disclosure to be used as a fabrication material for fluidic devices that mainly deal with aqueous solutions in biomedical applications.

In addition to the chemical compatibility with aqueous solutions, the silmer/AA/GMA polymer should have a high level of biocompatibility properties to be qualified for its application involving or related to biomedical processes. In some scenarios, the silmer/AA/GMA polymer may require a relative cell viability greater than about 70% upon co-culturing with living cells to be regarded as non-cytotoxic. As shown in FIG. 7c, the silmer/AA/GMA polymer, regardless of the AA and GMA content, was revealed to be non-cytotoxic as reflected by its highly comparable relative cell viability when compared against the control group at Day 4 of cell culturing. The non-cytotoxic properties of the silmer/AA/GMA polymer are further reaffirmed by the similar cell distribution and cell morphology as the control group as demonstrated by the microscope images of the cells for the respective experimental sets in FIG. 7c. With its non-cytotoxic properties, the silmer/AA/GMA polymer represents a new class of silicone-based ink material catering to biomedical applications.

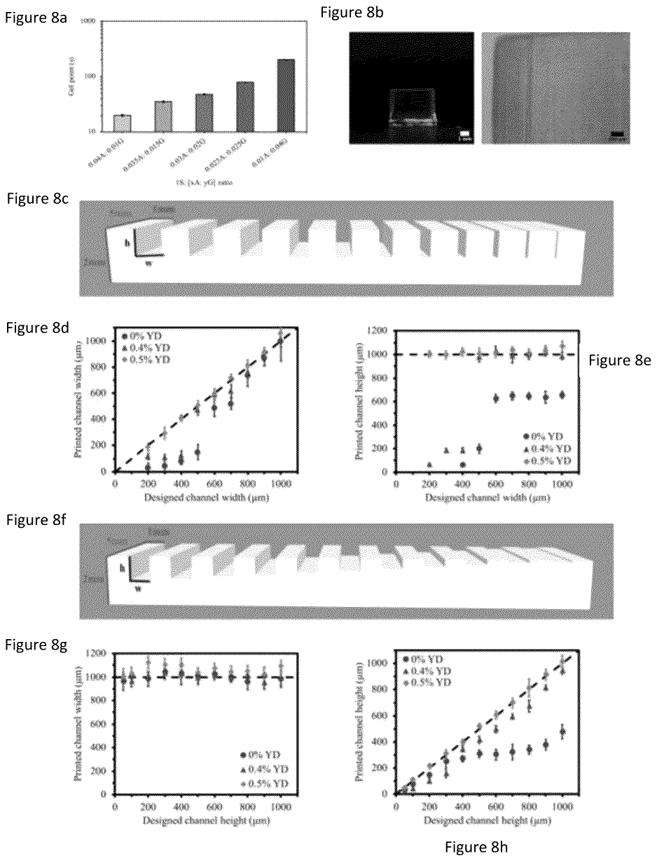

With respect to printing using the specific embodiment of the silmer/AA/GMA polymer, ink or material, prior to printing, the gel point of the silmer/AA/GMA polymer was evaluated using a SLA printer. The gel point is identified as the minimum or low time required to transform the liquid pre-gel solution to solid cured gel when being exposed to the UV light emitted from the bottom of the printing vat. This serves as a reference for the optimization of the UV exposure time required per printing layer. As shown in FIG. 8a, it was determined that the silmer/AA/GMA polymer required a longer gelation time with a higher gel point as the AA content reduces with the increase in GMA content. Specifically, the gel point of the silmer/AA/GMA polymer was found to increase exponentially with the reduction of AA content as the GMA content increases, leading to a 10-fold increase in gelation time as the AA content reduces from 0.04 to 0.01 part with respect to the increase in GMA content from 0.01 to 0.04 part. The slower polymerization rate with GMA is attributed to steric hindrance contributed by the extra methyl group bound to the alpha carbon of the —C═C bond. Methacrylates are often included as part of the formulation for acrylate-based resin material for better distortion resistance owing to their relatively slow polymerization rate.

Following the identification of the gel point, the UV exposure time per printing layer can be improved according to the gel point obtained for the respective resin formulation. Oftentimes, the solid gel formed at the gel point is mechanically fragile, making it unsuitable for printing as it fails to survive the printing process. In conjunction with that, a longer UV exposure time than the gelation time, as specified by the gel point, is necessary to further crosslink the polymer or ink for sufficient green strength to withstand the printing process. Exposure of the ink to UV for between about 2 to 4 additional seconds of exposure time on top of the gel point is adequate to provide the silmer/AA/GMA polymer with sufficient green strength to withstand the printing process. With the goal of achieving improved integration between the layers, an experiment was performed with printing the silmer/AA/GMA polymer with a UV exposure time per printing layer of 4 seconds in addition to the gelation time as specified by the gel point. Upon the determination of a beneficial UV exposure time according to the gel point, all the silmer/AA/GMA polymers with varying AA and GMA content were successfully printed with SLA printing. In one specific embodiment of printing fluidic devices using the specific embodiment of the ink of the disclosure, it was determined that an ink based on the silmer/AA/GMA polymer having 0.04 part of AA and 0.01 part of GMA with respect to 1 part of silmer was reduced to practice.

In some embodiments, the printing resolution of the silmer/AA/GMA polymer can be further improved with the addition of coloring dye as a photo absorber. In combination with the specific embodiment of the ink of the disclosure, a yellow dye was added to the silmer/AA/GMA polymer due to its light absorption properties near the wavelength of UV light emitted by the SLA printer at around 405 nm.

In other experiments to test the ink of the disclosure, the printing resolutions of the ink of the disclosure in terms of channel width and height were evaluated with the test models as shown in FIGS. 8c and 8f, respectively. With respect to channel width, a test model with a gradual reduction in channel width from about 1000 to about 50 μm paired with a constant channel height at about 1000 μm was used to evaluate the resolution of printed channel width. As shown in FIGS. 8d and 8e, the addition of about 0.5% yellow dye was observed to generate a highly accurate channel width down to 200 μm without affecting the accuracy of the channel height. Both the channel width at 100 and 50 μm remained indistinguishable regardless of the dosage of yellow dye. On the other hand, without the incorporation of yellow dye, the SLA printer was able to print the channels with less accuracy for channel widths below about 600 μm as schematically shown in FIG. 8d.

Additionally, despite the successful printing of channels with a channel width of 600 μm and above, for the fluidic device printed without the yellow dye, the printed channels were observed to experience a compromised channel height at about 40% reduction in dimension as compared to the targeted height as schematically shown in FIG. 8e. The failure to generate accurate channel width below 600 μm and the significant deviation in channel height of the printed channels are highly attributed to the overcuring of pre-gel solution trapped within the channel as the excessive light penetrates through the designated layer thickness in the absence of yellow dye to function as the photo absorber. Hence, the inclusion of dye plays may further reduce photocuring depth for a better printing accuracy of channel width down to 200 μm without affecting the accuracy of the channel height.

With respect to channel height, a test model with a gradual reduction in channel height from about 1000 to about 50 μm paired with a constant channel width at 1000 μm was employed to evaluate the resolution of the printed channel height as schematically shown in FIG. 8f. The addition of yellow dye enabled the generation of a channel height closely matching that of the targeted height down to about 50 μm with no impact on the accuracy of the channel width as schematically shown in the charts of FIGS. 8g and 8h. Differing from the results shown for the evaluation of the printing resolution for channel width, all the channel widths were accurately printed regardless of the channel height dimension as schematically shown in the chart of FIG. 8g. Additionally, the accurate channel width generated regardless of the dosage of yellow dye suggests that the effect of yellow dye is more prominent with smaller channel width dimension and that a large enough channel width can be printed accurately without the need for extra photocuring depth tuning or no dye.

Without the incorporation of yellow dye, the dimension of the printed channel height was reduced by approximately half of the targeted height for channels with a targeted channel height of 1000 to 400 μm as schematically shown in FIG. 8h. The channels with a targeted height of 300 μm and below were revealed to be relatively accurate even without the incorporation of yellow dye. The addition of the yellow dye had minimal or little impact on the appearance of the printed structure as shown by the highly transparent interface of the printed structure in FIG. 8b. The final printed structure exhibited excellent layer integration with good adhesion between the printed layers. Aside from the excellent layer integration, the printed structure had a smooth surface with no obvious signs of staircase effect at the edge. This further suggests the high surface quality of the printed structure generated by SLA printing using the ink of the disclosure.

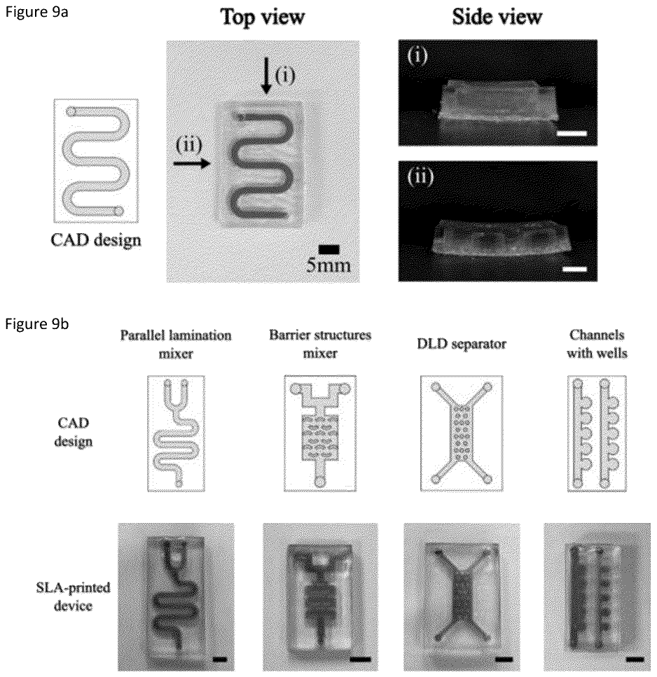

Following the determination of one set of optimal printing parameters, the potential to fabricate embedded-channel fluidic devices with the silmer/AA/GMA polymer or ink via SLA printing was further tested. In addition to the pre-gel properties, the position of the channel within the printed device was discovered to be important for the successful direct printing of fluidic devices with embedded channels. In some embodiments, the embedded channels are positioned near the top of the printed structure. This is to prevent or reduce the likelihood of the overcuring of any pre-gel solution trapped within the channel for the successful direct printing of embedded channels. The layer enclosing the roof of the embedded channel needs to be sufficiently thick to withstand the pressure of the fluid flowing through the channel. In experiments, it was determined that an embedded channel with a roof thickness of about 200 μm was beneficial for the printing of embedded channels with one embodiment of the ink of the disclosure. As shown in FIG. 9a, a fluidic device with an embedded serpentine channel was printed. The top view of the printed device displays the use of SLA printing with the ink of the disclosure in generating an exact replica of fluidic channels according to a CAD design version or rendering. The side views of the printed device revealed the features of the embedded channel enclosed within the printed structure.

Aside from the simple channel geometries, the printing of embedded-channel fluidic devices with multiple geometries was also tested. As shown in FIG. 9b, comparisons between CAD renderings and actual printed 3D structures using the ink of the disclosure are provided. In the example for parallel lamination mixing, the potential to generate a fluidic device with curved channels featuring a combination of the U-shaped channel and the serpentine channel was demonstrated and achieved. On the other hand, in the example for barrier structures mixing and deterministic lateral displacement (DLD) separating, the capability to print poles with different shapes and sizes was confirmed. Furthermore, in the example for channels with wells, the printing of irregular-shaped channels with horizontal wells was achieved. All the printed devices demonstrated excellent functionality according to their respective application as listed in FIG. 9b. Both the parallel lamination mixer and barrier structures mixer demonstrated excellent fluid mixing properties as red and blue dyes were pumped into the fluidic device which resulted in the homogeneous mixing of these dyes resulting in a purple solution near the output. As for the DLD separator, the distinct separation of red and blue dyes (pumped into the printed structure) by the circular poles positioned in the middle of the device affirmed the correct function of the DLD separator in flowing the fluids in two separate streams while allowing some fluid diffusion to occur as the streams converge near the poles. With respect to the channel with wells structure, the flowing of fluids through the channels with wells demonstrated that it could be used for continuous-flow cell culturing for disease modeling and drug testing. All the fluidic channels printed in FIG. 9b are in milli-scale to cater to the potential use of the printed device for biomedical applications requiring milli-scale channels, such as for, but not limited to, cell culturing and hydrogel particle synthesis for cell and drug encapsulation. It is understood that other fluid devices can be printed with micro-scale embedded-channel fluidic devices with the ink or material of the disclosure.

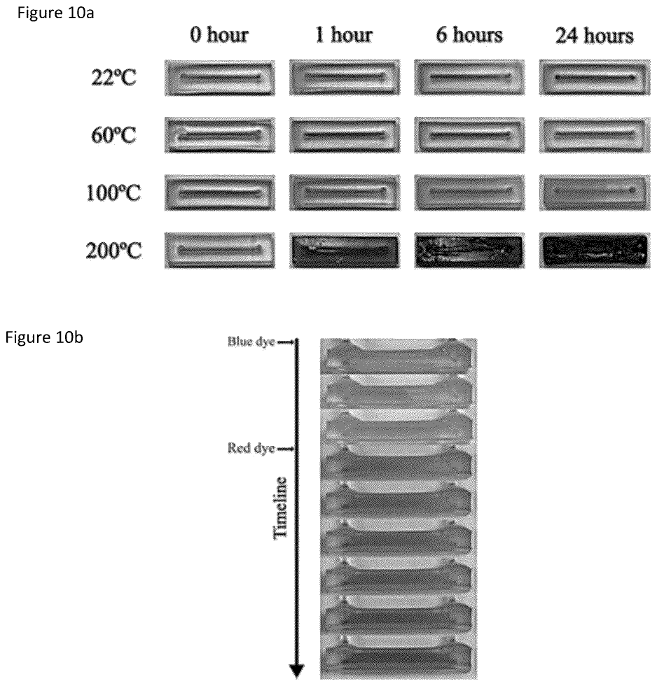

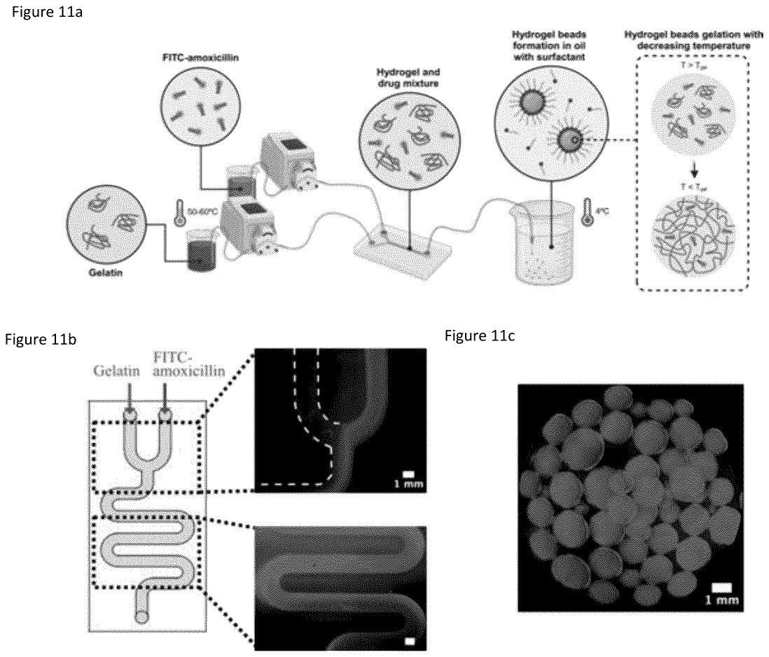

With respect to the functionality of the printed fluidic devices, the printed channels should possess the capability to process fluids efficiently without any instances of leakage. The fluidic channel's ability to process fluid was assessed through static and dynamic flow testing. As shown in FIG. 10a, the fluidic channel was observed to remain intact with no fluid leakage for up to 24 hours at room temperature (22° C.) when subjected to static flow. The effect of temperature on the functionality of the printed channel was also tested.

As shown in the images of FIG. 10a, the printed channel was capable of handling temperatures up to 100° C. for 24 hours with no fluid leakages detected. Moreover, the printed device was observed to have no signs of yellowing when subjected to elevated heat up to 100° C. for 24 hours. Overall, the printed device demonstrated an ability to process fluid(s) at elevated temperatures up to about 100° C. without signs of material degradation and/or fluid leakages.

Furthermore, the durability of the printed channel in handling continuous fluid flow was tested using a dynamic flow test. The printed channel was first flowed with blue dye followed by red dye to better visualize the continuous flow of fluid within the fluidic channel. As shown in FIG. 10b, the printed channel portrayed high functionality in processing the continuous flow of fluid as reflected by the gradual transition in fluid color from blue to red over time without any fluid leakages. Additionally, the durability of the fluidic channel with different flow rates was tested by simultaneously increasing the flow rate from about 0.1 to about 20 mL/min with a 15-minute interval between each flow rate upon switching. The printed channel remained intact with no fluid leakage observed up to the high flow rate of the dosing pump at 20 mL/min whereby it the capability of the printed device in handling continuous fluid to handle a relatively high flow rate was confirmed. Therefore, a fluid device printed using the ink of the disclosure showed that they were able to function with a high level of fluid processibility in terms of static and dynamic flow.

With respect to a sample application of a fluidic device that was printed using the ink of the disclosure, hydrogel beads synthesis for drug encapsulation was performed using the fluidic device as hydrogel beads have found their use in various biomedical applications, including drug delivery, cell delivery, and scaffold building. During testing, the potential of the fluidic device to synthesize drug-encapsulated hydrogel beads for drug delivery and effective fluid mixing was performed and schematically shown in FIG. 11a. Specifically, gelatin was employed as a hydrogel solution, while amoxicillin served as the medication solution. Gelatin was chosen for its thermo-reversible qualities, which enabled the production of a solid gel when the temperature decreased below its gelling point. Amoxicillin was chosen as the sample medication because it contains an amine group that can be labeled with fluorescein isothiocyanate (FITC), allowing for the visualization of the drug encapsulation within the hydrogel beads. Both the hydrogel and drug solution were then flowed through the printed device for a homogeneous mix. More specifically, the fluidic device that was printed included a parallel lamination mixer with serpentine mixing channels. FIG. 11b shows the capability of the printed device to effectively mix the hydrogel and drug solution for a homogeneous distribution of drugs within the hydrogel solution. Both the hydrogel and drug solution were observed to have maximum or a high level of contact with the fluidic channel, facilitating the effective fluid flow across the fluidic channel, owing to the hydrophilic surface of the developed material. Subsequently, the homogeneously mixed hydrogel and drug solution was extruded through a needle nozzle capped at the end of the output channel into the oil bath for hydrogel bead formation as schematically shown in FIG. 11a. The oil bath was added with a lipophilic surfactant, to help with the formation of perfectly round hydrogel beads as the hydrogel solution extruded from the needle nozzle. Moreover, the oil bath was maintained at a low temperature of approximately 4° C. This is because gelatin has a gelling temperature within the range of 22 to 25° C. FIG. 11c shows the successful synthesis of drug-encapsulated hydrogel beads as reflected by the homogeneous fluorescent appearance of each hydrogel bead. It is important to note that the size of the hydrogel beads can be further controlled by manipulating the flow rate of solution extruding out into the oil bath and the size of the needle nozzle head. The experiment reported here on the synthesis of hydrogel beads is to serve as a proof-of-concept on the practicability of the printed fluidic device when being applied for real-world biomedical applications. The successful synthesis of drug-encapsulated hydrogel beads provides further evidence for the feasibility of the printed device fabricated with the hydrophilic silicone-based ink or material of the disclosure for biomedical applications.

In other embodiments, the disclosure may be seen as a novel hydrophilic silicone-based resin ink or printing material with an amphiphilic siloxane monomer/oligomer as the primary composition complemented with AA and GMA for the SLA printing of embedded-channel fluidic devices catering to biomedical applications. In one embodiment, the disclosure includes altering silmer conformation via the dissolution of the ink components in predetermined solvents. In testing, amphiphilic siloxane-based resin ink or printing material demonstrated low pre-gel viscosity, high transparency and hydrophilicity which makes the ink of the disclosure suited for the SLA printing of biomedical devices. In other embodiments, the monomer ratio variation of the ink of the disclosure enables flexibility for mechanical properties tuning, owing to the role of AA in imparting strength and GMA in inducing elasticity in the overall ink of the disclosure.

Advantages of the disclosure include an excellent resistance towards polar solvent despite its hydrophilic properties, rendering it highly suitable for biomedical application by allowing the processing of aqueous solution without swelling upon contact. Another advantage of the disclosure is that it has non-cytotoxic properties. Regarding printability, all the silmer/AA/GMA polymers exhibit exceptional printability when the printing parameters are appropriately adjusted based on the gel point of each polymer, considering the different ratios of AA and GMA monomers.

It will be understood that the steps of the embodiments of the method of the disclosure as disclosed herein may be performed in any suitable order or sequence other than the disclosed order or sequence.

It will be appreciated by those skilled in the art that the disclosure can take many forms, and that such forms are within the scope of the invention as claimed. The scope of the claims should not be limited by the preferred embodiments set forth in the examples, but should be given the broadest interpretation consistent with the description as a whole.

What is claimed is:

1. A printable material for use in three-dimensional printing comprising:
an amphiphilic siloxane monomer/oligomer; and
a photoinitiator.

2. The printable material of claim 1 further comprising at least one crosslink monomer.

3. The printable material of claim 2 where the at least one crosslink monomer is acrylamide, glycidyl methacrylate, acrylic acid or (Hydroxyethyl) methacrylate.

4. The printable material of claim 1 further comprising a solvent for dissolving the amphiphilic siloxane monomer/oligomer.

5. The printable material of claim 4 wherein the solvent is ethanol, ethylene glycol, diethylene glycol, ethylhexanoic acid, dibenzyl ether, water, isopropyl alcohol or a combination thereof.

6. The printable material of claim 3 further comprising a solvent for dissolving the at least one crosslink monomer.

7. The printable material of claim 6 wherein the solvent is ethanol, ethylene glycol, diethylene glycol, ethylhexanoic acid, dibenzyl ether, ethanol, water, isopropyl alcohol or a combination thereof.

8. The printable material of claim 5 wherein the solvent comprises ethanol and ethylene glycol.

9. The printable material of claim 7 wherein the solvent comprises ethanol, ethylene glycol and water.

10. The printable material of claim 3 wherein the amphiphilic siloxane monomer/oligomer is silmer and the at least one crosslink monomer includes acrylamide and glycidyl methacrylate.

11. The printable material of claim 10 further comprising a solvent including ethanol, ethylene glycol and water for dissolving the silmer, acrylamide and glycidyl methacrylate.

12. A method of formulating a printable material for use in three-dimensional printing comprising:
mixing an amphiphilic siloxane monomer/oligomer with a photo initiator.

13. The method of claim 12 further comprising:
adding at least one crosslink monomer to the amphiphilic siloxane monomer/oligomer and photo initiator mixture.

14. The method of claim 13 further comprising dissolving the amphiphilic siloxane monomer/oligomer, the photo initiator and at least one crosslink monomer in a solvent to produce a first mixture.

15. The method of claim 14 wherein the at least one crosslink monomer is glycidyl methacrylate and the solvent is a combination of ethanol and ethylene glycol.

16. The method of claim 15 further comprising:
dissolving acrylamide in water to produce a second mixture; and
adding the second mixture to the first mixture.
